(19) United States
(12) Patent Application Publication
(10) Pub. No.: US 2015/0186455 A1
(43) Pub. Date: Jul. 2, 2015

(54) SYSTEMS AND METHODS FOR AUTOMATIC ELECTRONIC MESSAGE ANNOTATION

(71) Applicant: Google Inc., Mountain View, CA (US)

(72) Inventors: Bryan Christopher Horling, Mountain View, CA (US); David Nachum, Mountain View, CA (US); Harish Rajamani, Mountain View, CA (US)

(73) Assignee: Google Inc., Mountain View, CA (US)

(21) Appl. No.: 14/143,594

(22) Filed: Dec. 30, 2013

(51) Int. Cl. G06F 17/30

(52) U.S. Cl. CPC G06F 17/30424; G06F 17/30598; G06F 17/30554

(57) ABSTRACT

Systems and methods for annotating electronic messages are disclosed. In some implementations, a method includes, at a computing device, analyzing content of a first electronic message against a set of annotation rules; and in accordance with the analyzing: identifying a search term not included in the content of the first electronic message as associated with the first electronic message. In some implementations, the first set of annotation rules includes one of: a content based annotation, a syntax based annotation rule, and a hybrid annotation rule. In some implementations, the content of the electronic message includes one of: a text item, an audio item, an image item, and a video item.

### TECHNICAL FIELD

The implementations disclosed herein relate generally to annotating electronic messages.

### BACKGROUND

Nowadays, a user often receives hundreds, if not thousands, of electronic messages a day. For ease of reference (e.g., search) by a user, it may be preferred that messages are labeled as belonging to a particular content category (e.g., “contact numbers”) or having a particular type of content (e.g., a friend Joe's email), even though these message themselves do not include these term.

Difficulties abound with offering such a feature, however. One technical problem is that annotating messages with search terms that are not present within the messages involves analysis of the content of the messages and identifying appropriate annotation based on certain rules.

The above identified technical problems are addressed by the systems and methods disclosed herein.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is an example block diagram illustrating a computing system, in accordance with some implementations.

FIG. 2 is an example block diagram illustrating a computing device, in accordance with some implementations.

FIG. 3 is an example block diagram illustrating an annotation system, in accordance with some implementations.

FIG. 4 is an example flow chart illustrating a method for annotating electronic messages in a computing system, in accordance with some implementations.

FIGS. 5A-5B are example flow charts illustrating methods for annotating electronic messages, in accordance with some implementations.

FIG. 6 is a screen image showing an example user interface in which annotated electronic messages are displayed responsive to a user search, in accordance with some implementations.

### SUMMARY

Technical solutions (e.g., computing systems, methods, and non-transitory computer readable storage mediums) for annotating electronic messages are provided in the present application.

In some implementations, methods are provided for analyzing content of a first electronic message against a set of annotation rules and in accordance with the analyzing: identifying a search term not included in the content of the first electronic message as associated with the first electronic message. In some implementations, the set of annotation rules includes one of: a content based annotation, a syntax based annotation rule, and a hybrid annotation rule.

In some implementations, the search term is specified by a user. In some implementations, the search term is identified automatically without user intervention. In some implementations, the method also includes, in accordance with the analyzing, identifying the search term as associated with a second electronic message, where the first electronic message and the second electronic message are within a message cluster.

In some implementations, the method also includes, responsive to a user query including the search term, providing one or more electronic messages within the message cluster. In some implementations, the content of the electronic message includes one of: a text item, an audio item, an image item, and a video item.

In some implementations, the content of the electronic message includes an audio item and the analyzing of the content of the electronic message includes applying a speech recognition technique to the audio item to produce a corresponding text item. In some implementations, the content of the electronic message includes an image item having one or more characters and analyzing content of the electronic message includes applying an optical character recognition technique to the image item to identify the one or more characters. In some implementations, the content of the electronic message includes an image item having one or more objects and analyzing content of the electronic message includes applying an object recognition technique to the image item to identify the one or more objects. In some implementations, the content of the electronic message includes a video item having one or more objects; and analyzing content of the electronic message includes applying an object recognition technique to the video item to identify the one or more objects.

In some implementations, a computing system for annotating electronic messages includes one or more processors, memory, and one or more programs. The one or more programs are stored in the memory and are configured to be executed by the one or more processors. The one or more programs include instructions for analyzing content of a first electronic message against a set of annotation rules. In accordance with the analyzing, a search term, not included in the content of the first electronic message, is identified as associated with the first electronic message. In some implementations, the set of annotation rules includes one of: a content based annotation, a syntax based annotation rule, and a hybrid annotation rule. In some implementations, the search term is specified by a user. In some implementations, the search term is identified automatically without user intervention. In some implementations, the one or more programs further include instructions for, in accordance with the analyzing, identifying the search term as associated with a second electronic message, where the first electronic message and the second electronic message are within a message cluster. In some implementations, the one or more programs further include instructions that, responsive to a user query including the search term, provide one or more electronic messages within the message cluster. In some implementations, the content of the electronic message includes one of: a text item, an audio item, an image item, and a video item. In some implementations, the content of the electronic message includes an audio item; and analyzing content of the electronic message includes applying a speech recognition technique to the audio item to produce a corresponding text item. In some implementations, the content of the electronic message includes an image item having one or more characters; and analyzing content of the electronic message includes applying an optical character recognition technique to the image item to identify the one or more characters. In some implementations, the content of the electronic message includes an image item having one or more objects and analyzing content of the electronic message includes applying an object recognition technique to the image item to identify the one or more objects. In some implementations, the content of the electronic message includes a video item having one or more objects; and analyzing content of the electronic message includes: applying an object recognition technique to the video item to identify the one or more objects.

In some implementations, a non-transitory computer readable storage medium for annotating electronic message is provided. The non-transitory computer readable storage medium stores one or more programs. The one or more programs comprise instructions, which when executed by a computing system with one or more processors, cause the computing system to execute a method of analyzing content of a first electronic message against a set of annotation rules and, in accordance with the analyzing, identifying a search term not included in the content of the first electronic message as associated with the first electronic message. In some implementations, the set of annotation rules includes one of: a content based annotation, a syntax based annotation rule, and a hybrid annotation rule. In some implementations, the search term is specified by a user. In some implementations, the search term is identified automatically without user intervention. In some implementations, the method also includes, in accordance with the analyzing, identifying the search term as associated with a second electronic message, where the first electronic message and the second electronic message are within a message cluster. In some implementations, the method also includes, responsive to a user query including the search term, providing one or more electronic messages within the message cluster. In some implementations, the content of the electronic message includes one of: a text item, an audio item, an image item, and a video item. In some implementations, the content of the electronic message includes an audio item; and analyzing content of the electronic message includes applying a speech recognition technique to the audio item to produce a corresponding text item. In some implementations, the content of the electronic message includes an image item having one or more characters; and analyzing content of the electronic message includes applying an OCR technique to the image item to identify the one or more characters. In some implementations, the content of the electronic message includes an image item having one or more objects; and analyzing content of the electronic message includes: applying an object recognition technique to the image item to identify the one or more objects. In some implementations, the content of the electronic message includes a video item having one or more objects; and analyzing content of the electronic message includes: applying an object recognition technique to the video item to identify the one or more objects.

### DETAILED DESCRIPTION

The implementations described herein provide various technical solutions to improving access to electronic messages, and in particular to the above-identified problems, by providing techniques for annotating electronic messages and for providing annotated electronic messages responsive to a user search.

As a non-limiting example, after obtaining a string of emails (e.g., MSG 1, MSG 2, and MSG 3), an annotation system analyzes each of these emails for annotation purposes. In some cases, starting with MSG 1, the annotation system analyzes its content against a set of e.g., content-based annotation rules. In some cases, the annotation of MSG 1 includes: (a) searching for various keywords (e.g., “deal,” “itinerary,” “profile”) within different components of MSG 1 (e.g., message body, attachment, header, and subject line)

In some cases, starting with MSG 1, the annotation system analyzes its content against a set of e.g., syntax-based annotation rules. In some cases, the annotation of MSG 1 includes: (a) searching for content that have a commonly known format, such as phone number (which currently have ten digits in the United States, and the first three representing an area code can be verified against a database of phone area code), or email addresses (which currently include the character“@” or the phrase “at,” or phrases such as “.com”, “.edu”, or “.org”).

In some cases, the annotation system also uses a location service. For example, emails having addresses within two miles of a user's home residence are annotated as “Home”; and photos taken (e.g., identified by metadata) within 100 miles of a user's home residence are annotated as “Local.”

Next, based on annotations with which an email has been associated with (e.g., the term “Local”, the term “Home”, or both), the annotation system provides search results responsive to a search query. When a user enters a search term “Local”, photos taken 100 miles within the user's residence are provided as part of search results.

Providing at least these technical effects, the proposed technical solutions described in the present application address the above-identified technical problems in at least the following ways.

Electronic messages relevant to a user's search are provided, even though the messages do not always literally include a user provided search term, thereby improving search effectiveness and efficiency.

Additional details of implementations are now described in relation to the Figures.

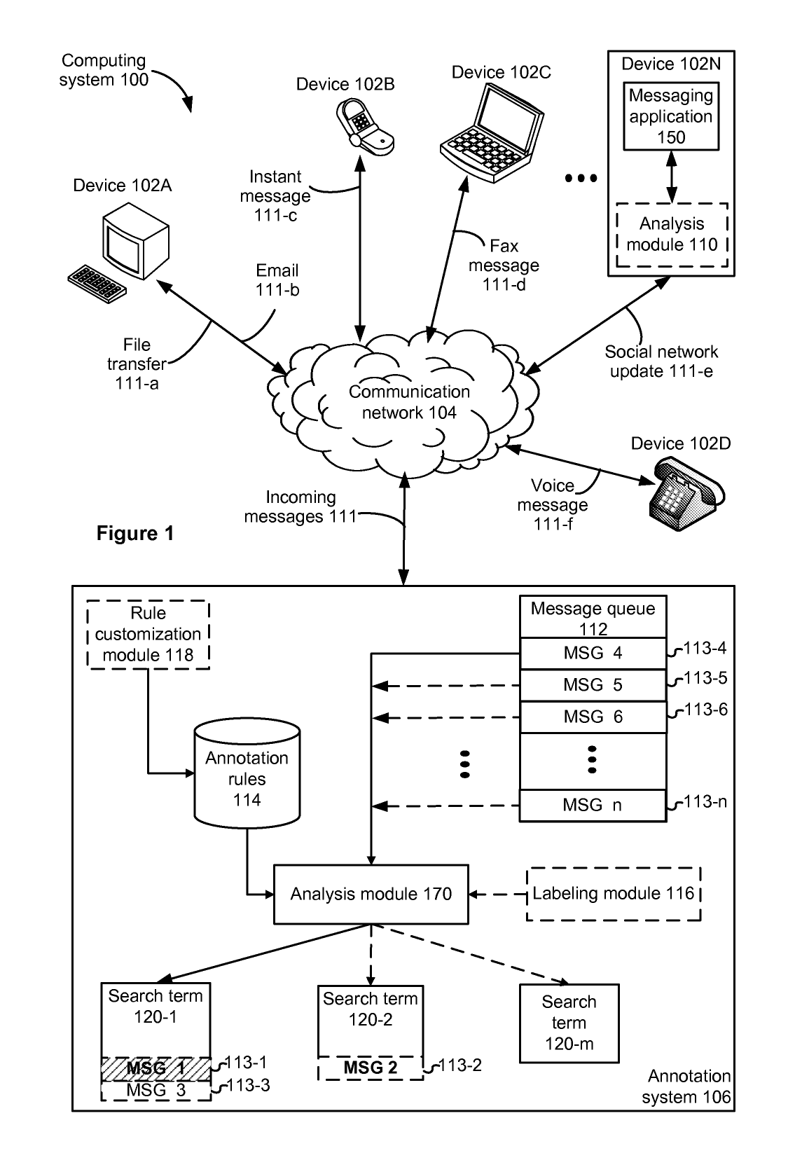

FIG. 1 is a block diagram illustrating a computing system 100, in accordance with some implementations.

In some implementations, the computing system 100 includes one or more devices 102 (e.g., device 102A, 102B, 102C, 102D . . . , and 102N), a communication network 104, and annotation system 106. In some implementations, a device 102 is a phone (mobile or landline, smart phone or otherwise), a tablet, a computer (mobile or otherwise), a fax matching, or an audio/video recorder.

In some implementations, a device 102 obtains an electronic message from (e.g., drafted or generated by) a user of the device 102, and transmits the electronic message to the annotation system 106 for annotation and optionally for clustering. For example, after determining that user Jack sends an email to user Mary, the device 102 transmits the email to the annotation system 106, which annotates messages for Mary.

In some implementations, an electronic message is a file transfer 111-a (e.g., a photo, document, or video download/upload), an email 111-b, an instant message 111-c (e.g., a GOOGLE HANGOUT message), a fax message 111-d, a social network update 111-e (e.g., a GOOGLE PLUS update), or a voice message 111-f.

In some implementations, a device 102 includes a messaging application 150 and optionally an analysis module 110 (similar to the analysis module 180 included in the annotation system 106). In some implementations, the messaging application 150 processes incoming and outgoing electronic messages into and from the device 102, such as an outgoing email sent by a user of the device 102 to another user, and a chat message by another user to a user of the device 102. In some implementations, the analysis module 110 resident on the device 102 balances processing load with the analysis module 170 resident on the annotation system 106. For example, after a user requests to send out a total of six emails, the analysis module 110 on the device 102 processes the first three emails (which include plain text emails, e.g., without HTML content or attachments, and thus might require less processing power), and the analysis module 170 on annotation system 106 processes the remaining three emails (which include HTML content or attachments, and thus might require more processing power).

In some implementations, the communication network 104 interconnects one or more devices 102 with each other, and with the annotation system 106. In some implementations, the communication network 104 optionally includes the Internet, one or more local area networks (LANs), one or more wide area networks (WANs), other types of networks, or a combination of such networks.

In some implementations, the annotation system 106 includes an analysis module 170, a message queue 112, a collection of (e.g., syntax- and content-based) annotation rules 114 (e.g., user- or system-provided rules), optionally a labeling module 116, and optionally a rule customization module 118.

In some implementations, the annotation system 106 analyzes content of incoming electronic messages (e.g., incoming messages 111), and associates one or more search terms (annotations) 120 to such messages. For example, after analyzing the message body of an email (e.g., MSG 1, MSG 2, and MSG 3), the annotation system 106 determines (e.g., with a 90% confidence level) that MSG 1 includes a phone number and so the search term “phone” 120-1 is accordingly associated with the email. In some implementations, associating a search term with an electronic message includes assigning a label (a “phone number”) to the electronic message using the labeling module 116.

In some implementations, the analysis module 170 analyzes content of an electronic message against e.g. syntax- and content-based annotation rules. For example, the analysis module 170 conducts a syntax (e.g., a search of digits having a phone number like format, e.g., (123)-456-7890) and content search (e.g., a search of the term “deal” or the phrase “low price”) within various content components (e.g., message body, subject line, sender/recipient, and header section) of an electronic message, and then analyzes search results using annotation rules (e.g., whether the term “deal” appears more than three times within the body of an email, or whether the phrase “low price” appears within the subject line of a fax message).

In some implementations, based on the results of the analysis, the analysis module 170 identified one or more index terms for an electronic message; e.g., after determining that the term “deal” appears more than four times in the message body of an email and that the term “travel” appears in the subject line of the email, the analysis module 170 assigns index terms “Promotion” and “Travel” to the electronic message. In some implementations, as explained in the above example, an electronic message is assigned to more two or more index terms. These approaches are advantageous, because sometimes an electronic message can be reasonably (e.g., objectively) considered as falling into two or more content categories. In one example, an email promoting a discount cruise trip is considered by some users as relevant to both “Travel” and “Promotion”; as such, the email is responsive to a search of “Travel” emails as well as to that of “Promotion” emails.

In some implementations, however, an electronic message is assigned to one index term only. For example, a message only appears in a search for “Travel” emails, but not in that of “Promotion” emails. These approaches are also advantageous, because user access may be simplified and user confusion minimized, when an electronic message is assigned to a single index term.

In some implementations, the analysis module 110 is a software or hardware component resident on the device 102, such as a software package/application or a hardware chipset, for clustering messages, and analysis module 170 on server 106 is not used. In some implementations, the analysis module 110 is not present and analysis module 170, which exists separate from or independent of the device 102 is used (e.g., a GOOGLE mail annotation server that is connected with but not part of the device 102, e.g., in the manner depicted in FIG. 1 with analysis module 170). In still other implementations, the analysis module 110 is a software or hardware component resident on the device 102, such as a software package/application or a hardware chipset, for annotating messages, and analysis module 170 on server 106 is also used. That is, both analysis module 110 on device 102 and analysis module 170 on server 106 are used. For instance, in some such embodiments some annotation rules 114 (e.g. user-specified rules) are implemented on device 102 and implemented using analysis module 110 and some annotation rules 114 (e.g., system-provided rules) are implemented on server 106 and implemented using analysis module 170.

In some implementations, the message queue 112 stores one or more electronic messages awaiting analysis by the analysis module 170, such as MSG 4, MSG 5, MSG 6, . . . and MSG n (FIG. 1, 113-4 . . . 113-n). In some implementations, the message queue 112 includes different types of electronic messages, such as a file transfer 111-a (e.g., a photo, document, or video upload), an email 111-b, an instant message 111-c (e.g., a Google HANGOUT message), a fax message 111-d, a social network update 111-e (e.g., a GOOGLE PLUS update), or a voice message 111-f.

In some implementations, the collection of (e.g., content-based) annotation rules 114 include system- and user-specified annotation rules. In some implementations, system-provided rules are determined by the annotation system 106 (e.g., default annotation rules), and user-specified rules are customized (e.g., added, removed, or modified) by a user.

In some implementations, the labeling module 116 labels an electronic message using a flag in accordance with to which annotations associated with an electronic message. For example, after an email is annotated as “Travel” or “Promotion,” the labeling module 116 assigns both the label “Travel” or the label “Promotion” to the electronic message, and makes these labels available (visually) to users. These approaches are advantageous, because message labels may simplify searches and selective retrievals of electronic messages, e.g., electronic messages may be searched, and retrieved, both using labels.

In some implementations, a rule customization module 118 enables a user to customize (e.g., add, remove, and modify) annotation rules within the collection of annotation rules 114. These approaches enable customizing annotation rules to a user's specific need. For instance, users residing within the continental U.S. may consider an electronic message having the term “Alaska” associated with a “Travel” message (e.g., an electronic message with top-rated Alaska destinations) or a “Promotion” message cluster (e.g., an electronic message including promotional materials for trips to Alaska); users residing in the state of Alaska, however, might consider such electronic message “Local” or “Home” in nature and classify it as such.

In some implementation cases, therefore, a user can personalize existing annotation rules. Continuing with the above example, in some cases, a user living Alaska can modify annotation rules 114 such that electronic messages including the term “Alaska” are annotated as “Home” or “Local” (associated with the search term “Home” or “Local,” or both, or their synonyms)—rather than the search term “Promotion” or “Travel” cluster, as users living in the continental U.S. may do.

In some embodiments, this example is addressed in system-defined rules by examining the geographic source or geographic destination of the electronic message, or by otherwise determining a way to associate a geographic location with the electronic message (e.g., by recognizing an address within the message) and applying a geographic dependent annotation rule to the message. In some embodiments, the geographic source or geographic destination is approximated based on an origination IP address or a destination IP address. To illustrate, if a geographic destination for a respective electronic message is within the continental U.S., the term “Alaska” within the message is used to assign the electronic message to a “Travel” cluster. If a geographic destination for a respective electronic message is within the state of Alaska, the term “Alaska” within the message is used to associate with search terms such as “Travel” or “Trip.”

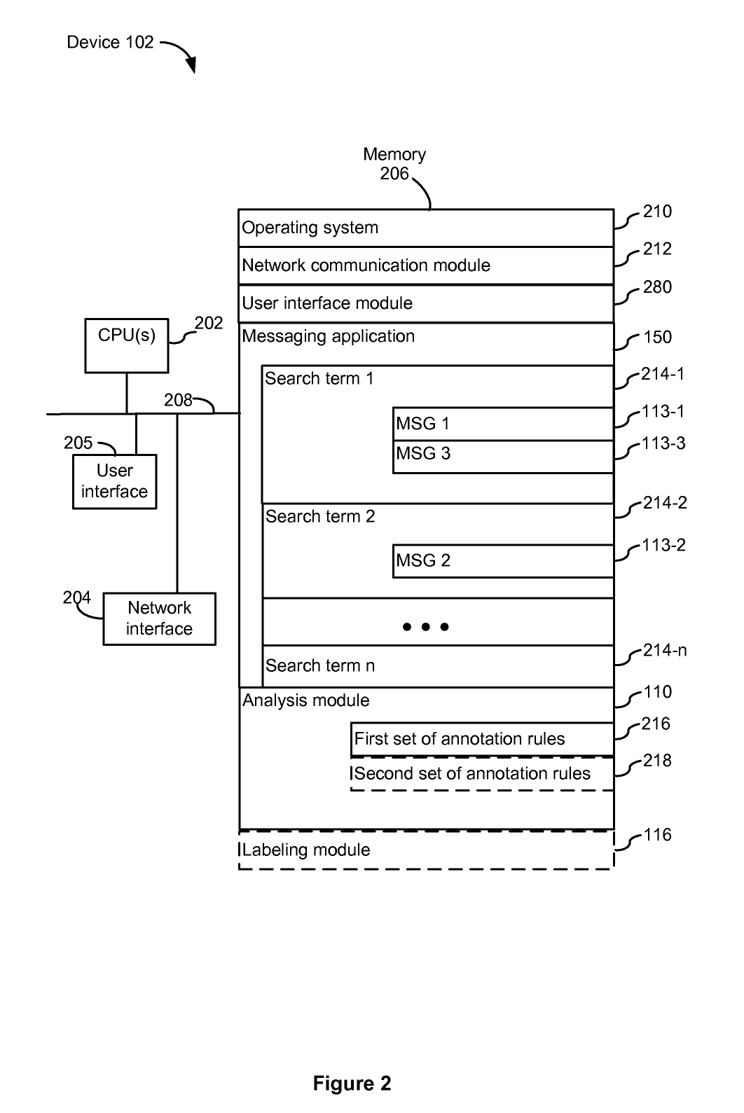

FIG. 2 is a block diagram illustrating a computing device 102, in accordance with some implementations. The device 102 in some implementations includes one or more processing units CPU(s) 202 (also referred to as processors), one or more network interfaces 204, a user interface 205, a memory 206, and one or more communication buses 208 for interconnecting these components. The communication buses 208 optionally include circuitry (sometimes called a chipset) that interconnects and controls communications between system components. The memory 206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternatively the non-volatile memory device(s) within the memory 206, comprises a non-transitory computer readable storage medium. In some implementations, the memory 206 or alternatively the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the device 102 with other devices (e.g., the annotation system 106 and the devices 102B . . . 102N) via one or more network interfaces 204 (wired or wireless), or the communication network 104 (FIG. 1);
a user interface module 280 for displaying user interface components or controls (e.g., textbox, button, radio button, drop-down list) to a user;
a messaging application 150 for processing, searching, and displaying incoming and outgoing electronic messages in accordance with annotations therefore, including:
   a cluster graphic 1 (214-1) that visually clusters (e.g., groups together) MSG 1 (113-1) and MSG 3 (113-1)—both of which have been assigned to message cluster 1;
   a cluster graphic 2 (214-2) that visually clusters (e.g., groups together) MSG 2 (113-2)—which has been assigned to message cluster 2; and
   a cluster graphic n (214-n) that visually clusters (e.g., groups together) electronic messages that have been assigned to message cluster n;
optionally an analysis module 110 for annotating (e.g., income and outgoing) electronic messages, e.g., a first set of annotation rules (syntax based) 216 or a second set of annotation rules (content based) 218, and identifying index search terms as associated with electronic messages in accordance with therewith; and
optionally a labeling module 116 for labeling an electronic message in accordance with clustering result therefore, and assisting the search of electronic messages using labels (e.g., search all “Travel” emails—emails that have been assigned to the “Travel” cluster and thus labeled as “Travel” emails).

In some implementations, the user interface 205 includes an input device (e.g., a keyboard, a mouse, a touchpad, a track pad, and a touch screen) for a user to interact with the device 102.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above.

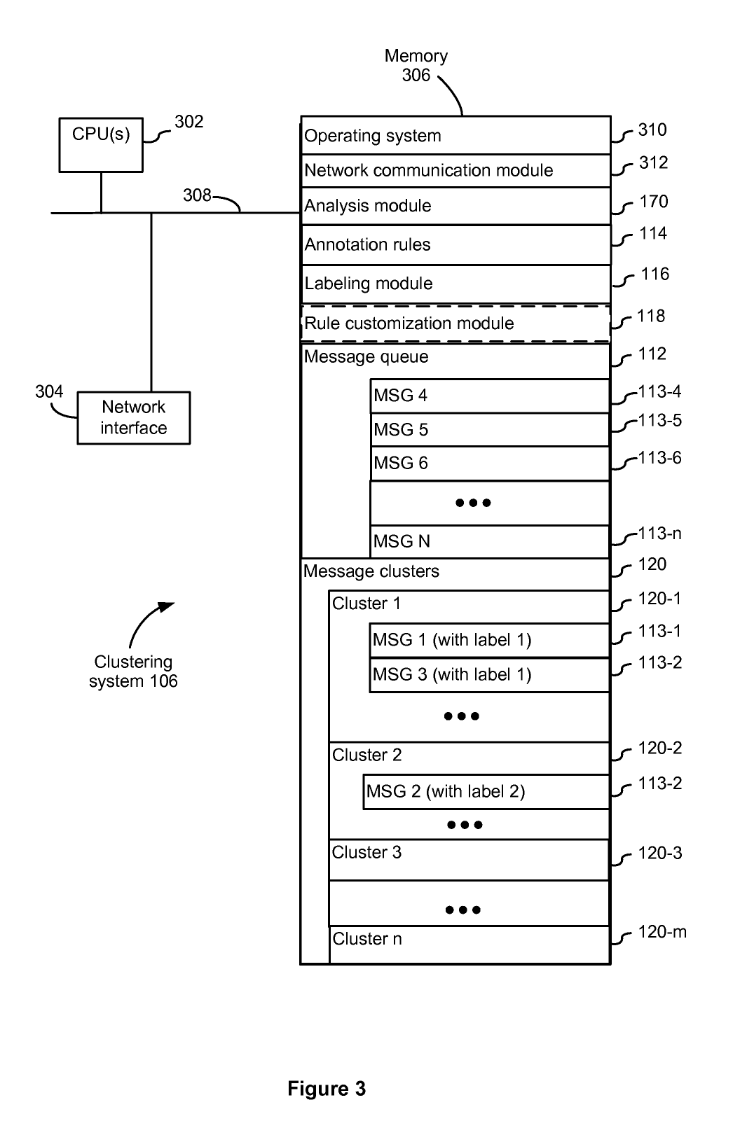

FIG. 3 is a block diagram illustrating an annotation system 106, in accordance with some implementations. The annotation system 106 typically includes one or more processing units CPU(s) 302 (also referred to as processors), one or more network interfaces 304, memory 306, and one or more communication buses 308 for interconnecting these components. The communication buses 308 optionally include circuitry (sometimes called a chipset) that interconnects and controls communications between system components. The memory 306 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 306 optionally includes one or more storage devices remotely located from CPU(s) 302. The memory 306, or alternatively the non-volatile memory device(s) within the memory 306, comprises a non-transitory computer readable storage medium. In some implementations, the memory 306 or alternatively the non-transitory computer readable storage medium stores the following programs, modules and data structures, or a subset thereof:
an operating system 310, which includes procedures for handling various basic system services and for performing hardware dependent tasks;
a network communication module (or instructions) 312 for connecting the annotation system 106 with other devices (e.g., the devices 102) via the one or more network interfaces 304 (wired or wireless), or the communication network 104 (FIG. 1);
an analysis module 170 for imposing an annotation (content- or syntax-based) on (e.g., incoming and outgoing) electronic messages in accordance with one or more sets of annotation rules;
a message queue 112 for storing electronic messages awaiting processing by the analysis module 180, e.g., MSG 4, MSG 5, MSG 6, . . . and MSG n (113-4 . . . 113-n);
a collection of annotation rules 114, which specify or determine, e.g., with a predefined degree of certainty, one or more index terms (e.g., content categories) associated with an electronic message;
optionally a labeling module 116 for labeling an electronic message in accordance with annotations therefore, and assisting the search for electronic messages using labels (e.g., search all “Travel” emails—emails that have been assigned to the “Travel” cluster and thus labeled as “Travel” emails).
a rule customization module 118 for enabling a user to customize (e.g., add, remove, and modify) the collection of annotation rules 114; and
one or more message clusters 120 for storing or representing electronic messages assigned thereto, which include:
   cluster 1 (120-1, e.g., the “Travel” cluster) for representing (e.g., grouping together) electronic messages assigned thereto, which include:
      MSG 1 (e.g., with label 1); and
      MSG 3 (e.g., with label 1);
   cluster 2 (120-2, e.g., the “Promotion” cluster) for representing (e.g., grouping together) electronic messages assigned thereto, which include:
      MSG 2 (e.g., with label 2);
   cluster 3 (120-3, e.g., the “Primary” cluster) for representing (e.g., grouping together) electronic messages assigned thereto; and
   cluster n (120-n, e.g., the “Social” cluster) for representing (e.g., grouping together) electronic messages assigned thereto.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 306 optionally stores a subset of the modules and data structures identified above. Furthermore, the memory 306 may store additional modules and data structures not described above.

Although FIGS. 2 and 3 show a “device 102” and an “annotation system 106,” respectively, FIGS. 2 and 3 are intended more as functional description of the various features which may be present in computer systems than as a structural schematic of the implementations described herein. In practice, and as recognized by those of ordinary skill in the art, items shown separately could be combined and some items could be separated.

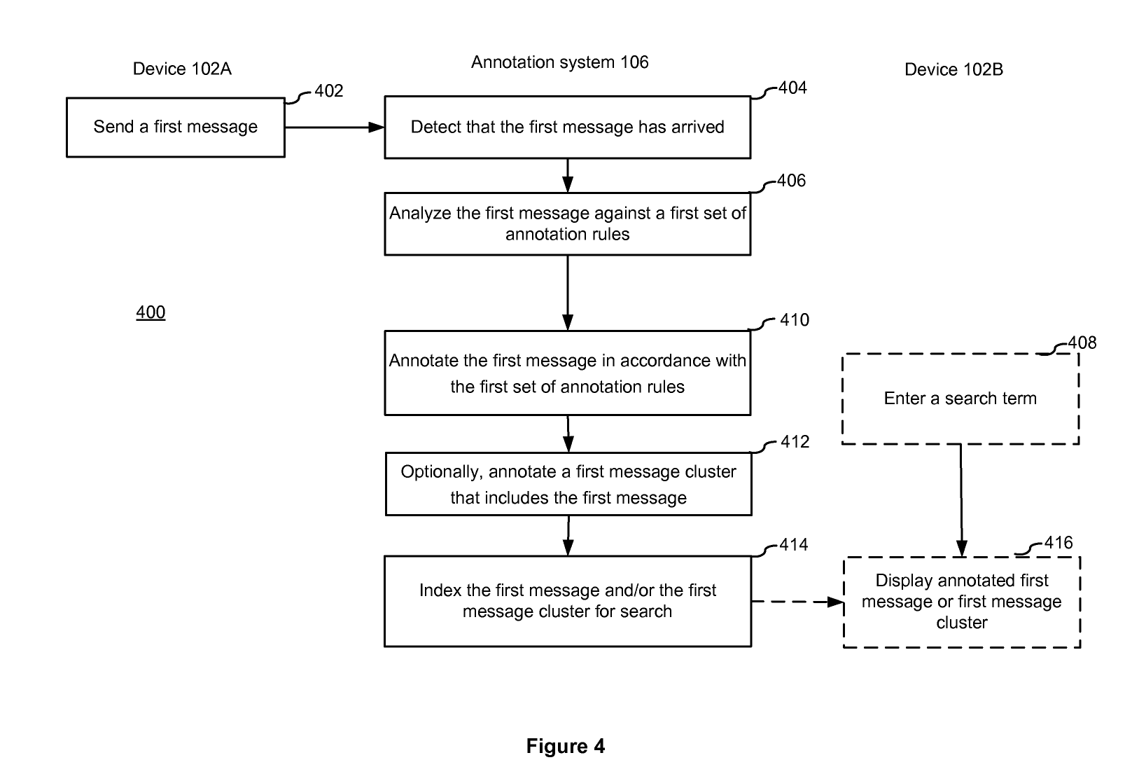

FIG. 4 is a flow chart illustrating a method for clustering electronic messages in a computing system, e.g., implemented at device 102, at the annotation system 106, in accordance with some implementations.

In some implementations, the device 102A sends (402) a first electronic message to the device 102B, via the annotation system 106.

In some implementations, after detecting (404) that the first message has arrived, the annotation system analyzes (406) the first message against a first set of annotation rules. In some implementations, the set of annotation rules includes one of a content based annotation, a syntax based annotation rule, and a hybrid annotation rule. In some implementations, the search term is specified by a user. In some implementations, the search term is identified automatically without user intervention.

In some implementations, the annotation system annotates (410) the first message. In some implementations, the content of the electronic message includes one of: a text item, an audio item, an image item, and a video item. In some implementations, the content of the electronic message includes an audio item and analyzing content of the electronic message includes: applying a speech recognition technique to the audio item to produce a corresponding text item. In some implementations, the content of the electronic message includes an image item having one or more characters and analyzing content of the electronic message includes applying an optical character recognition technique to the image item to identify the one or more characters. In some implementations, the content of the electronic message includes an image item having one or more objects and analyzing content of the electronic message includes applying an object recognition technique to the image item to identify the one or more objects. In some implementations, the content of the electronic message includes a video item having one or more objects and analyzing content of the electronic message includes applying an object recognition technique to the video item to identify the one or more objects.

In some implementations, the annotation system annotates (412) a first message cluster that includes the first message. Clusters are described in U.S. patent application Ser. No. 14/139,205, filed Dec. 23, 2013, entitled “Systems and Methods for Clustering Electronic Messages,” which is hereby incorporated by reference herein in its entirety. Whereas conversations aggregate electronic messages based on content relatedness (e.g., header content relatedness) between messages already in the conversations and messages being considered for assignment to conversations, electronic messages are organized into clusters without regard to content relatedness between messages within the clusters and messages being considered for assignment to the clusters. For example, a string of messages from and to a first and second user or group of users are good candidates for inclusion in a conversation because of the content relatedness between the messages in the conversations and the messages being considered for the conversations. However, absent some additional criterion or factor, the relatedness in the source and destination of these messages does not serve as a basis for inclusion in the same cluster.

In some implementations, the annotation system indexes (414) the first message, and/or the first message cluster in anticipation of a user search. This indexing makes use of the annotation (additional search term) that was used to annotate the first message. More specifically, the first message and/or the first message cluster is indexed in such a manner that the annotation (additional search term) is deemed to be in the first message and/or the first message cluster in accordance with the set of annotation rules, even when, in fact, the search term is not explicitly present in the first message and/or first message cluster.

In some implementations, a user of the device 102B enters a search term, textual or visual query search, and as a result the device 102B searches a plurality of electronic messages (e.g. a corpus of electronic messages) that includes, among other things, the annotated first message and/or first annotated first message cluster that includes the search term that the user of the device 102B entered because the search term entered by the user matches or is equated to the annotation added to the first message and/or first annotated message cluster. Accordingly, there is provided a search result, the first message (and/or the first message cluster), to the user of the device 102B.

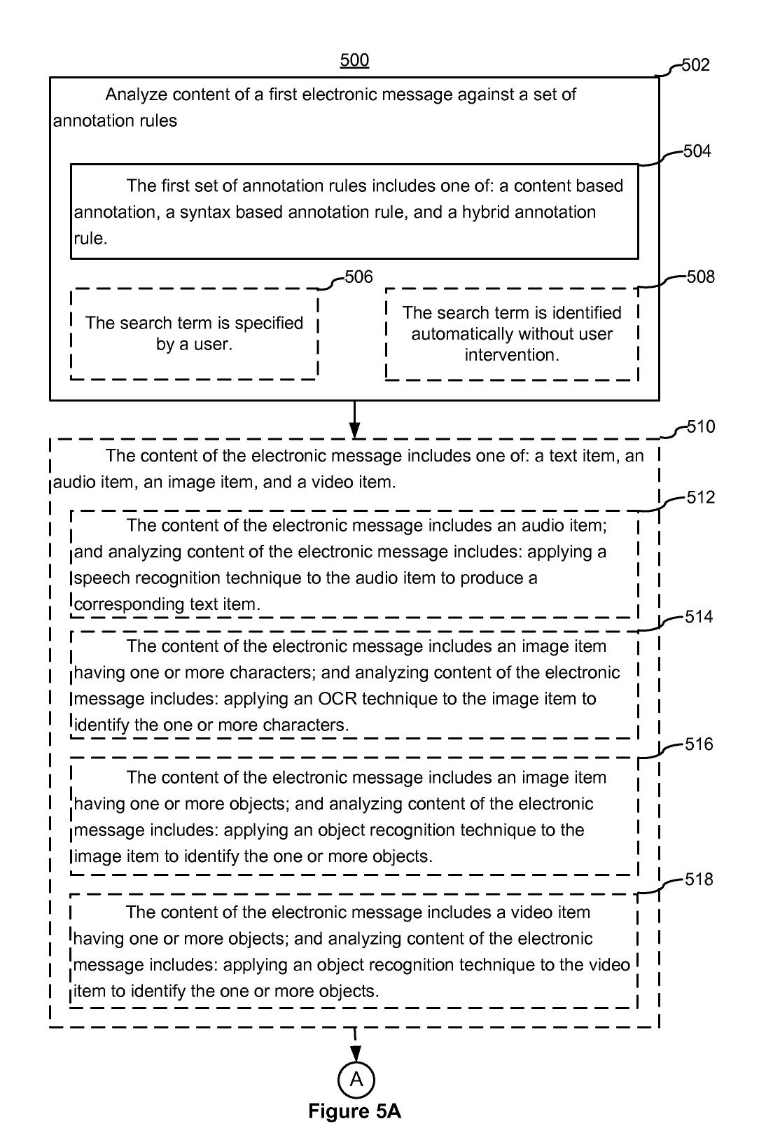

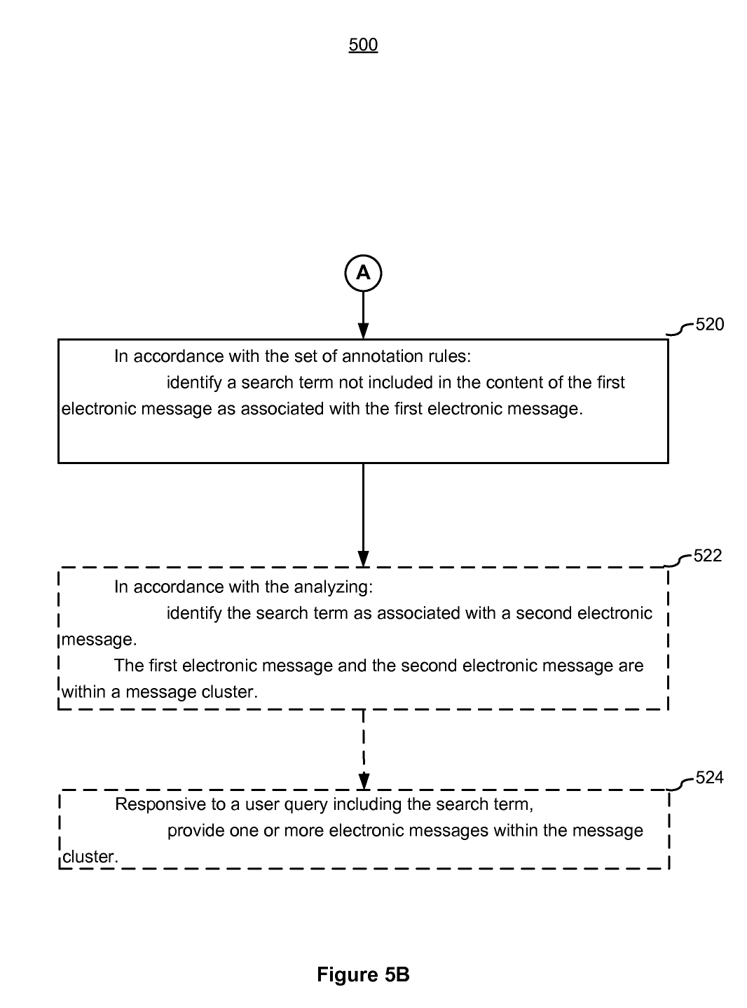

FIGS. 5A-5B are example flow charts illustrating methods for annotating electronic messages, in accordance with some implementations.

In some implementations, the method 500 for annotating electronic messages is performed at a computing system, e.g., the device 102. In some implementations, the device 102 includes one or more processors and memory storing one or more programs for execution by the one or more processors. In some implementations, the electronic device includes what is referred to in some contexts as a client-side device. In some implementations, the electronic device includes a smartphone (e.g., a GOOGLE ANDROID phone), a mobile computer (e.g., a GOOGLE NEXUS computer, a laptop and a notebook), or a desktop computer.

In some implementations, a method for analyzing electronic messages includes, at a computing device, analyzing (502) content of a first electronic message against a set of annotation rules and, in accordance with the set of annotation rule (520) (FIG. 5B) a search term not included in the content of the first electronic message as associated with the first electronic message.

In some implementations, the set of annotation rules includes (504) one of: a content based annotation, a syntax based annotation rule, and a hybrid annotation rule. In some implementations, the search term is specified by a user (506). In some implementations, the search term is identified automatically without user intervention (508). In some implementations, the content of the electronic message includes (510) one of: a text item, an audio item, an image item, and a video item.

In some implementations, the content of the electronic message includes (512) an audio item and analyzing content of the electronic message includes: applying a speech recognition technique to the audio item to produce a corresponding text item.

In some implementations, the content of the electronic message includes (514) an image item having one or more characters; and analyzing content of the electronic message includes: applying an optical character recognition technique to the image item to identify the one or more characters.

In some implementations, the content of the electronic message includes (516) an image item having one or more objects and analyzing content of the electronic message includes applying an object recognition technique to the image item to identify the one or more objects.

In some implementations, the content of the electronic message includes (518) a video item having one or more objects; and analyzing content of the electronic message includes applying an object recognition technique to the video item to identify the one or more objects.

In some implementations, the method also includes (522), in accordance with the analyzing: identifying the search term as associated with a second electronic message, where the first electronic message and the second electronic message are within a message cluster.

In some implementations, the method also includes (524), responsive to a user query including the search term, providing one or more electronic messages within the message cluster.

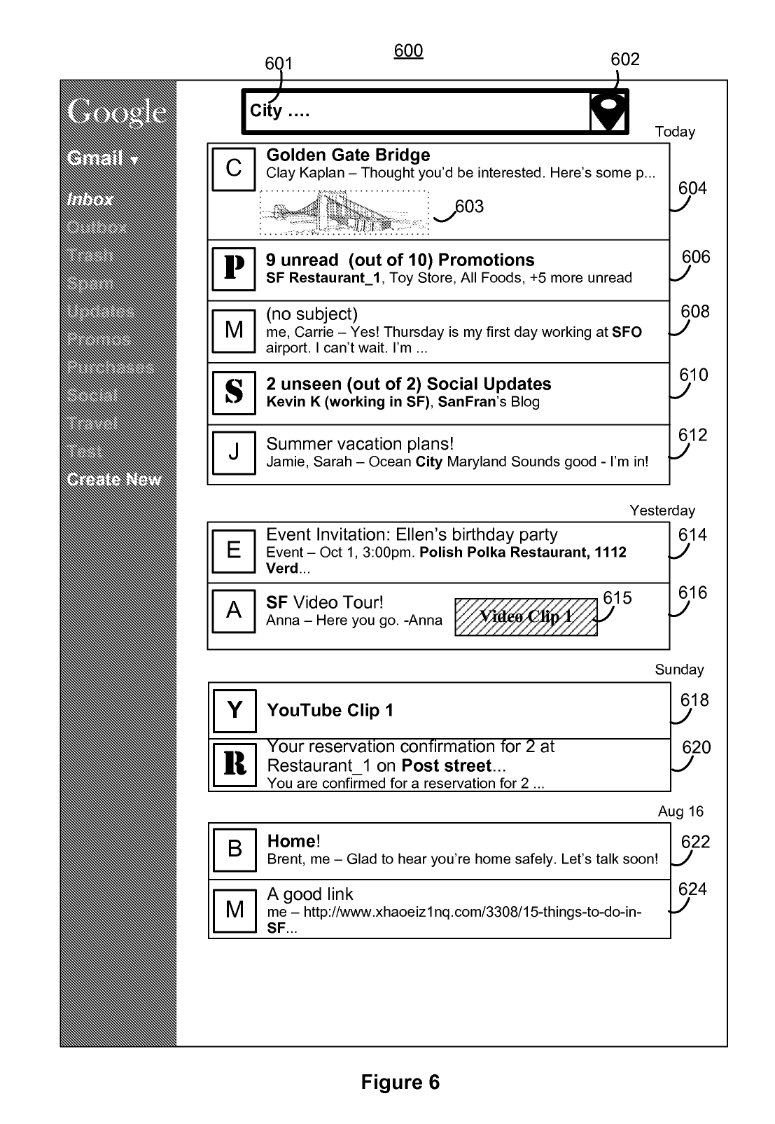

FIG. 6 is a screen image showing an example user interface 600 in which annotated electronic messages are displayed responsive to a user search, in accordance with some implementations. As shown in FIG. 6, a user enters a search term 601 “City” (e.g., case sensitive or otherwise). In response to the search term “City,” a plurality of annotated electronic messages is displayed.

Icon 602 represents a location service which provides an approximated location of a user conducting the search, e.g., by using an IP address of a computing device the user is using. In some implementations, the location service is turned off by a user to protect privacy. In this case, the location is the user has been determined to be located in San Francisco, Calif.

As shown in FIG. 6, responsive to the search term 601, an email 604 is displayed. The email 604 includes a subject line “Golden Gate Bridge,” as well as an inline photo 603 of the Golden Gate Bridge in the city of San Francisco, Calif.

As shown in FIG. 6, responsive to the search term 601, a message cluster 606 including 10 “Promotion” messages is displayed. A “Promotion” message concerning a restaurant in San Francisco, Calif. “SF Restaurant_{—}1” is displayed, among several other messages.

As shown in FIG. 6, responsive to the search term 601, a message conversation 606 including 2 messages is displayed. A message within the conversation 606 concerns an airport near San Francisco, Calif. “SFO” is displayed, among several other messages.

As shown in FIG. 6, responsive to the search term 601, a “Social” message cluster 610 is displayed. In particular, a GOOGLE PLUS update from Keven K, who, per his social profile is “working in SF” (SF is a shorthand for San Francisco, Calif.) is displayed. Also displayed is a webblog titled “SanFran's blog.”

As shown in FIG. 6, responsive to the search term 601, an individual message 612 is displayed. The individual message 61 includes the search term 601 “City.” The individual message 601 otherwise includes no content relating to San Francisco, Calif.

As shown in FIG. 6, responsive to the search term 601, an event invitation 614 is displayed. The event invitation 614 includes an address (Polish Polka Restaurant, 1112 Verd), which the location service determines, e.g., using an address database or a map service, to be an address within San Francisco, Calif.

As shown in FIG. 6, responsive to the search term 601, a chat message 616 including an attachment 615 is displayed. The body of the chat message 616 includes no content relating to San Francisco, Calif.; while the attachment 615 include video content concerning a “SF Video Tour.”

As shown in FIG. 6, responsive to the search term 601, a GOOGLE YOUTUBE clip 618 is displayed. The clip 618 includes image content relating to San Francisco, Calif.

As shown in FIG. 6, responsive to the search term 601, a fax message 620 (e.g., OCR'd or e-fax) is displayed. The fax message 620 includes text content relating to a restaurant reservation in Post Street, which is located in San Francisco, Calif.

As shown in FIG. 6, responsive to the search term 601, another email 622 titled “Home” is displayed. The “Home” represents a location of the user's residence in the city of San Francisco, Calif.

As shown in FIG. 6, responsive to the search term 601, another message 624 is displayed. The message 624 includes a reference, e.g., an URL, which include the word “SF’ common shorthand for San Francisco, Calif.).

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first electronic message could be termed a second electronic message, and, similarly, a second electronic message could be termed a first electronic message, without changing the meaning of the description, so long as all occurrences of the “first electronic message” are renamed consistently and all occurrences of the “second electronic message” are renamed consistently. The first electronic message and the second electronic message are both electronic messages, but they are not the same electronic message.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

1. A method comprising:
at a computing device having one or more processors and memory storing one or more programs for execution by the one or more processors:
analyzing a message body of a first electronic message against a set of annotation rules, wherein the set of annotation rules includes at least a syntax based annotation rule, wherein analyzing the message body of the first electronic message includes searching the message body for content matching a format specified by the syntax based annotation rule; and
in accordance with an analysis indicating that the message body of the first electronic message includes content matching the format specified by the syntax based annotation rule:
identifying, as associated with the first electronic message, a search term corresponding to the syntax based annotation rule; and
updating an index associated with a plurality of electronic messages including the first electronic message to include information identifying the search term as being present in the first electronic message,
responsive to a user query including the search term,
providing a search result from among a plurality of electronic messages that are deemed to satisfy the user query, wherein the search result includes the first electronic message on the basis that the index specifies that the message body of the first electronic message includes the search term, and wherein the search term is not included in the message body of the first electronic message.

2. The method of claim 1, wherein the set of annotation rules further includes a hybrid annotation rule.

3. The method of claim 1, wherein the search term is specified by a user.

4. The method of claim 1, wherein the search term is identified further in accordance with a location of the computing device.

5. The method of claim 1, further comprising:
in accordance with the analyzing:
identifying the search term as associated with a second electronic message, wherein the first electronic message and the second electronic message are within a message cluster.

6. The method of claim 5,
wherein the search result includes the message cluster.

7. The method of claim 6, wherein the providing further comprising formatting the message cluster for display as a first single cluster graphic, the method further comprising:
responsive to a predefined user action in connection with the first single cluster graphic:
expanding display of the single cluster graphic, by:
while maintaining display of information representing the electronic messages in the message cluster, formatting for display content of the first electronic message.

8. The method of claim 1, wherein the message body of the first electronic message includes one of: a text item, an audio item, an image item, and a video item.

9. The method of claim 1, wherein the message body of the first electronic message includes an audio item; and analyzing the message body of the first electronic message includes: applying a speech recognition technique to the audio item to produce a corresponding text item that is analyzed against the set of annotation rules.

10. The method of claim 1, wherein the message body of the first electronic message includes an image item having one or more characters; and analyzing the message body of the first electronic message includes: applying an optical character recognition technique to the image item to identify the one or more characters and applying the one or more characters against the set of annotation rules.

11. The method of claim 1, wherein the message body of the first electronic message includes an image item having one or more objects; and analyzing the message body of the first electronic message includes: applying an object recognition technique to the image item to identify one or more objects and applying the one or more objects against the set of annotation rules.

12. The method of claim 1, wherein the message body of the first electronic message includes a video item having one or more objects; and analyzing the message body of the first electronic message includes: applying an object recognition technique to the video item to identify the one or more objects and applying the one or more objects against the set of annotation rules.

13. The method of claim 1, wherein an annotation rule in the set of annotation rules makes use of a predetermined phone number format, a predetermined email format, a predetermined address format, a predetermined country code format, and/or a predetermined geographical location format.

14. A computing system, comprising:
one or more processors;
memory; and
one or more programs, wherein the one or more programs are stored in the memory and are configured to be executed by the one or more processors, the one or more programs including instructions for:
analyzing a message body of a first electronic message against a set of annotation rules, wherein the set of annotation rules includes at least a syntax based annotation rule, wherein analyzing the message body of the first electronic message includes searching the message body for content matching a format specified by the syntax based annotation rule; and
in accordance with an analysis indicating that the message body of the first electronic message includes content matching the format specified by the syntax based annotation rule:
identifying, as associated with the first electronic message, a search term corresponding to the syntax based annotation rule; and
updating an index associated with a plurality of electronic messages including the first electronic message to include information identifying the search term as being present in the first electronic message,
responsive to a user query including the search term,
providing a search result from among a plurality of electronic messages that are deemed to satisfy the user query, wherein the search result includes the first electronic message on the basis that the index specifies that the message body of the first electronic message includes the search term, and wherein the search term is not included in the message body of the first electronic message.

15. The computing system of claim 14, wherein the
providing comprises formatting for display the search result.

16. The computing system of claim 15, wherein
the search result includes a message cluster;
the first electronic message is in the message cluster; and
the message cluster includes one or more other electronic messages, and wherein the formatting for display comprises formatting the message cluster for display as a first single cluster graphic.

17. The computing system of claim 16, the one or more programs further comprising instructions for:
responsive to a predefined user action in connection with the first single cluster graphic:
expanding display of the first single cluster graphic, by:
while maintaining display of information representing the electronic messages in the message cluster, formatting for display content of the first electronic message.

18. A non-transitory computer readable storage medium storing one or more programs, the one or more programs comprising instructions, which when executed by a computing system with one or more processors, cause the computing system to execute a method of:
analyzing a message body of a first electronic message against a set of annotation rules, wherein the set of annotation rules includes at least a syntax based annotation rule, wherein analyzing the message body of the first electronic message includes searching the message body for content matching a format specified by the syntax based annotation rule; and
in accordance with an analysis indicating that the message body of the first electronic message includes content matching the format specified by the syntax based annotation rule:
identifying, as associated with the first electronic message, a search term corresponding to the syntax based annotation rule; and
updating an index associated with a plurality of electronic messages including the first electronic message to include information identifying the search term as being present in the first electronic message, and
responsive to a user query including the search term,
providing a search result from among a plurality of electronic messages that are deemed to satisfy the user query, wherein the search result includes the first electronic message on the basis that the index specifies that the message body of the first electronic message includes the search term, and wherein the search term is not included in the message body of the first electronic message.

19. The non-transitory computer readable storage medium of claim 18,
wherein the providing comprises formatting for display the search result.

20. The non-transitory computer readable storage medium of claim 19, wherein
the search result includes a message cluster;
the first electronic message is in the message cluster; and
the message cluster includes one or more other electronic messages, and wherein the formatting comprises formatting the message cluster for display as a first single cluster graphic.
